(19) United States
(12) Patent Application Publication
(10) Pub. No.: US 2025/0346211 A1
(43) Pub. Date: Nov. 13, 2025

(54) LEVER MEMBER, WIPER LEVER ASSEMBLY AND WIPER BLADE

(71) Applicant: DENSO CORPORATION, Kariya-city (JP)

(72) Inventors: Shusuke YOSHIMURA, Kariya-city (JP); Jun HAMAMOTO, Kariya-city (JP); Hiroki NOSE, Kariya-city (JP)

(73) Assignee: DENSO CORPORATION, Kariya-city (JP)

(21) Appl. No.: 19/276,229

(22) Filed: Jul. 22, 2025

Related U.S. Application Data
(63) Continuation of application No. PCT/JP2024/004630, filed on Feb. 9, 2024.

(30) Foreign Application Priority Data
Mar. 2, 2023 (JP) 2023-032235

(51) Int. Cl. B60S 1/38

(52) U.S. Cl. CPC B60S 1/38; B60S 2001/3812

(57) ABSTRACT

A lever is made of resin and constitutes a part of a wiper lever assembly that supports a blade rubber. The lever includes a coupling part having a coupling shaft to be coupled to a wiper arm. Further, the lever includes a pair of arm parts composed of a first arm part and a second arm part extending in mutually different directions from the coupling part. In addition, the lever includes a convex part protruding from the coupling part, formed at a center part between an end part of a first arm part opposite to the coupling part and an end part of a second arm part opposite to the coupling part.

This application is the U.S. bypass application of International Application No. PCT/JP2024/004630 filed on Feb. 9, 2024, which designated the U.S. and claims priority to Japanese Patent Application No. 2023-032235 filed on Mar. 2, 2023, and the contents of both of these are incorporated herein by reference

### BACKGROUND

### Technical Field

The present disclosure relates to a lever member, a wiper lever assembly and wiper blade.

### Description of the Related Art

A wiper blade for wiping water drops or the like adhered to a windshield glass of a vehicle is known. For example, a wiper blade is provided with a main lever made of resin coupled to a wiper arm via a coupling clip is known. Further, an opening is formed in a center part of the main lever in the longitudinal direction. Inside the opening, a coupling shaft made of metal, to which the coupling clip is engaged, is disposed across the opening by an insert-molding.

### SUMMARY

As a first aspect of the present disclosure, a lever member is made of resin that constitutes a part of a wiper lever assembly that supports a blade rubber, including: a coupling part having a coupling shaft to be coupled to a wiper arm; a pair of arm parts extending in mutually different directions from the coupling part, the pair of arm parts being a first arm part and a second arm part; and a convex part protruding from the coupling part, formed at a center part between an end part of a first arm part opposite to the coupling part and an end part of a second arm part opposite to the coupling part.

### BRIEF DESCRIPTION OF THE DRAWINGS

The above-described objects and other objects, features and advantages of the present disclosure will be clarified further by the following detailed description with reference to the accompanying drawings. The drawings are:

FIG. 1 is a diagram showing a perspective view of a wiper blade;

FIG. 2 is a diagram showing a perspective view of a wiper blade in which an illustration of a pair of wings is omitted;

FIG. 3 is a diagram showing a perspective view of a wiper blade in which an illustration of a lever and a pair of wings are omitted;

FIG. 4 is a diagram showing a side view of the wiper blade in a disassembled state;

FIG. 5 is a diagram showing a perspective view of the wiper blade in a disassembled state;

FIG. 6 is a diagram showing a bottom view of the lever according to a first embodiment when viewed from the lower side;

FIG. 7 is an explanatory diagram showing a filling of resin material using a cross-sectional view of the lever sectioned along 7-7 line shown in FIG. 6;

FIG. 8 is a diagram showing a front view of a center part of the lever when viewed from a front side;

FIG. 9 is a diagram showing a bottom view of the lever according to a second embodiment when viewed from a lower side;

FIG. 10 is a diagram showing a front view of the lever according to the second embodiment when viewed from a front side;

FIG. 11 is a bottom view diagram schematically showing a weld position formed at the lever according to the second embodiment;

FIG. 12 is a bottom view diagram schematically showing a weld position formed at the lever according to a third embodiment;

FIG. 13 is a bottom view diagram schematically showing a weld position formed at a lever according to a comparative example; and

FIG. 14 is a diagram showing a bottom view of a lever according to a fourth embodiment when viewed from a lower side.

### DETAILED DESCRIPTION OF THE PREFERRED EMBODIMENTS

A wiper blade for wiping water drops or the like adhered to a windshield glass of a vehicle is known. For example, JP-A-2020-45034 discloses a wiper blade provided with a main lever made of resin coupled to a wiper arm via a coupling clip. Further, an opening is formed in a center part of the main lever in the longitudinal direction. Inside the opening, a coupling shaft made of metal to which the coupling clip is engaged, is disposed across the opening by an insert-molding.

According to a lever member such as a main lever manufactured through a process in which a resin material is filled inside the mold, during the process, the resin material may preferably be filled inside the mold uniformly with a relatively low pressure. However, according to the configuration disclosed by the above-mentioned patent literature, such a process for uniformly filling resin material is not considered.

Hereinafter, with reference to the drawings, embodiments of the present disclosure will be described.

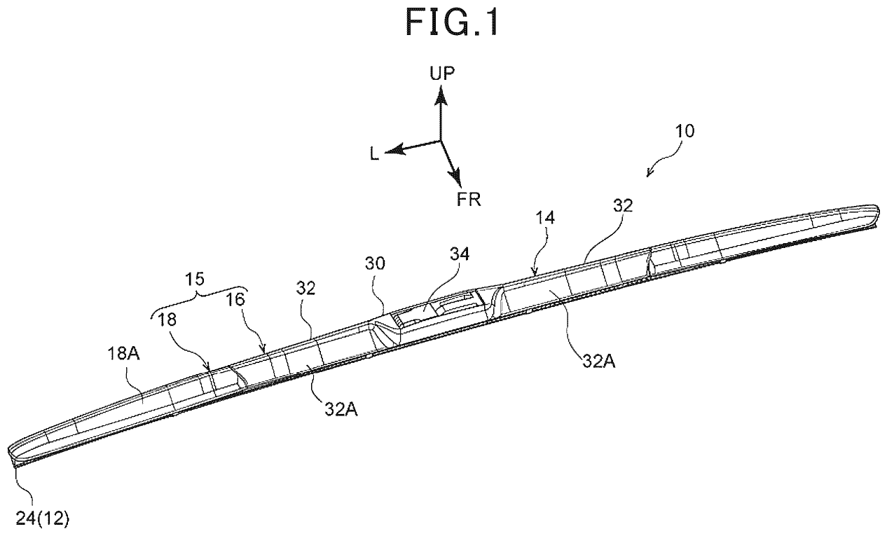

With reference to FIGS. 1 to 5, a wiper blade 10 provided with a lever 16 according to a first embodiment will be described.

As shown in FIGS. 1 to 5, the wiper blade 10 according to the present embodiment is for wiping water drops or the like adhered to a wiping surface as an outer surface of a windshield of a vehicle. Note that the wiper blade 10 according to the present embodiment is a wiper blade to which a structure of a wiper lever assembly forming a tournament structure is applied. The tournament structure of the wiper lever assembly is configured of a plurality of levers hierarchically coupled in a tournament chart structure.

The wiper blade 10 is coupled to a tip end part of a wiper arm (not shown) via a coupling clip 34, and receives a pressing force from the wiper arm to a wiping surface side of the windshield glass. Note that the wiper arm together with the wiper blade 10 and a wiper motor constitute a vehicle wiper apparatus. Then, the wiper arm rotates around a pivot shaft (not shown) to move in one side and the other side, whereby the wiper blade 10 reciprocates (deviates) towards one side and the other side in the wiping direction along the wiping surface of the windshield glass. An arrow UP in the drawings indicates an upper side of the wiper blade 10 with respect to the vertical direction. The upper side of the wiper blade 10 extends in a direction substantially orthogonal to the wiping surface of the windshield glass. Also, an arrow L in the drawings indicates one side of the wiper blade 10 in the longitudinal direction. Further, an arrow FR in the drawings indicates one side of the direction where the wiper blade 10 reciprocates. One side of the direction where the wiper blade 10 reciprocates is oriented towards a front side and obliquely lower side of the vehicle in a state where the vehicle wiper apparatus is stopped. In the following description, the vertical direction of the wiper blade 10 and the longitudinal direction of the wiper blade 10 are simply referred to as vertical direction and longitudinal direction, respectively. Moreover, one side and the other side of the direction where the wiper blade 10 reciprocates are referred to as front side and rear side, respectively.

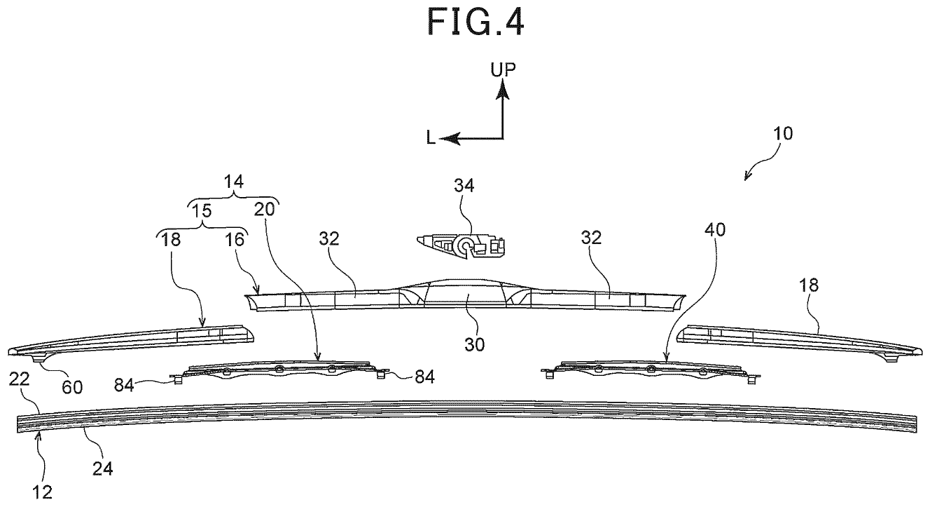

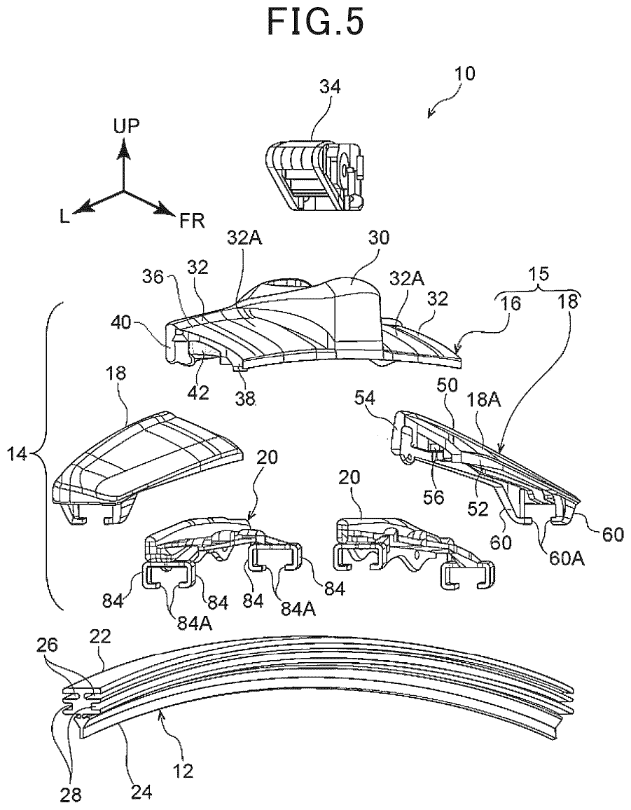

As shown in FIGS. 4 and 5, the wiper blade 10 is configured of a blade rubber 12 for wiping the wiping surface of the windshield glass, a wiper lever assembly 14 for supporting the blade rubber 12 and a coupling clip 34 for rotatably coupling the wiper lever assembly 14 to the wiper arm.

The wiper assembly 14 is configured of a lever 16 as a lever member to which the tip end part of the wiper arm is coupled to a center part of the lever 16 in the longitudinal direction, a pair of wing members 18 arranged continuously at both sides of the lever 16 in the longitudinal direction thereof, constituting an appearance design together with the lever 16, and a pair of yoke members 20 to which the lever 16 and the pair of wing members 18 are coupled. The wiper lever assembly 14 is configured to support the blade rubber 12 using the pair of wing members 18 and the pair of yoke member 20.

### (Configuration of Blade Rubber 12)

The blade rubber is formed of a rubber material such as EPDM (ethylene propylene diene rubber) having a longitudinal shape. The blade rubber 12 is provided with a base part 22 supported by the wiper lever assembly 14 and a wiping part 24 of which the lower end part is pressed on the wiping surface of the windshield glass, extending in the lower side from the base part 22. At the base part 22 of the blade rubber 12, a pair of backing grooves 26 that open at both sides in the front-rear direction are formed along the longitudinal direction. For each of these backing grooves 26, a backing (not shown) configured of a plate spring material made of metal is fitted therein. These backings are for dispersing a pressing force applied to the wiping surface from the wiper arm to be in the longitudinal direction. Further, for the base part 22 of the blade rubber 12, a pair of support grooves 28 that open at both sides in the front-rear direction are formed along the longitudinal direction in a lower side of the pair of backing grooves 26.

### (Configuration of Wiper Lever Assembly 14)

The wiper lever assembly 14 is configured of, as described above, the lever 16, the pair of wing members 18 and the pair of yoke members 20. Note that the wiper lever assembly 14 is symmetrically formed in the longitudinal direction with a portion where the wiper arm is coupled as a center, when viewed from the front side.

### (Configuration of Lever 16)

The lever 16 is, for example, made of a resin material and formed in a long-length shape in a longitudinal direction. The lever 16 constitutes a longitudinal intermediate part of the wiper lever assembly 14. For the lever 16, a longitudinal center part thereof serves as a coupling part 30, and both sides of the coupling part 30 in the longitudinal direction serve as a pair of arm parts 32 (a first arm part and a second arm part).

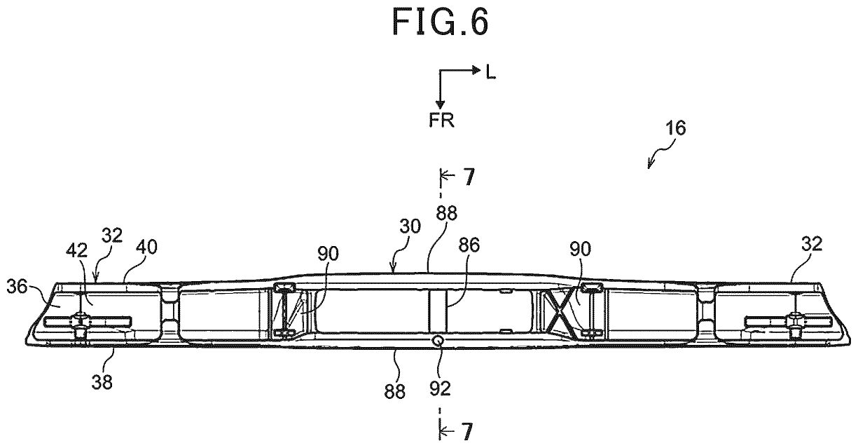

As shown in FIG. 6, the coupling part 30 is formed in a rectangular frame shape when viewed from the vertical direction, and the coupling part 30 penetrates in the vertical direction and opens in a rectangular shape. Inside the coupling part 30, a coupling shaft 86 which will be described later is disposed. A coupling clip 34 is attached to the coupling shaft 86, being rotatably around the coupling shaft 86, and the tip end part of the wiper arm is coupled thereto via the coupling clip 34.

The pair of arm parts 32 extend from the coupling part 30 towards one side and the other side in the longitudinal direction respectively. These arm parts 32 open towards a lower side when viewed in the longitudinal direction of the lever 16 to have an opening section shape.

As shown in FIG. 5, the arm parts 32 is each provided with an upper wall 36, a front wall 38 extending in the lower side from the front end part of the upper wall 36, and a rear wall 40 extending in the lower side from the rear end part of the upper wall 36. Further, a yoke member arrangement concave part 42 of which the lower side is opened is formed between the front wall 38 and the rear wall 40 of the arm part 32 along the longitudinal direction. Note that the upper surface of each arm part 32 serves as an inclined surface 32A upwardly inclined towards the rear end side.

### (Configuration of Wing Member 18)

As shown in FIGS. 4 and 5, the pair of wing members 18 are made of a resin material for example. Specifically, the pair of wing members 18 are formed in a longitudinal shape with a resin material same as that of the lever 16 to have the same overall texture, since the pair of wing members 18 constitutes most of the appearance design of the wiper blade 10. These wing members 18 are continuously arranged in one side and the other side of the lever 16 in the longitudinal direction. Also, respective wing members 18 are configured to open towards the lower side to have an opening section shape.

As shown in FIG. 5, respective wing members 18 are each provided with an upper wall 50, a front wall 52 extending in the lower side from the front end part of the upper wall 50, and a rear wall 54 extending in the lower side from the rear end part of the upper wall 50. Further, a yoke member arrangement concave part 56 of which the lower side is opened is formed between the front wall 52 and the rear wall 54 of the respective wing members 18 along the longitudinal direction, where concave part is continuously formed together with the yoke member arrangement concave part 42 in the assembled state. Thus, a part of the lever 16 side in the respective wing members 18 is configured similar to the arm part 32 of the lever 16. The upper surfaces of the respective wing members 18 serves as, similar to the upper surface of the arm part 32, an inclined surface 18A upwardly inclined towards the rear side. Then, the respective wing members 18 and the above-described lever 16 serve as a blade body 15 that constitutes an appearance design surface side of the wiper blade 10.

Moreover, a grip member 60 (first grip member) with which a longitudinal end part of the blade rubber 12 is gripped, is formed at an end part of each wing member 18 positioned opposite to the lever 16. The grip member 60 has a pair of grip pieces 60A disposed in the front and rear side, extending in the lower side from the front wall 52 and rear wall 54. The tip end parts (lower end parts) of the grip pieces 60A in the front and rear sides are bent approaching each other, and engaged into the above-described pair of support grooves 28. Thus, the longitudinal end part of the blade rubber 12 is supported by the grip member 60. An engagement concave part (not shown) at which the tip end part of the grip piece 60A is engaged, is formed at one end part in the longitudinal direction of the pair of support grooves 28 of the blade rubber 12. The engagement concave part prevents the blade rubber 12 from becoming detached from the wiper assembly 14 in the longitudinal direction.

### (Yoke Member 20)

A pair of yoke members 20 are formed in a long-length shape in a longitudinal direction. The respective yoke members 20 are each configured such that a metal plate being cut in a predetermined shape is caused to be bent. Note that one side yoke member 20 and the other side yoke member 20 are configured to have substantially the same structure.

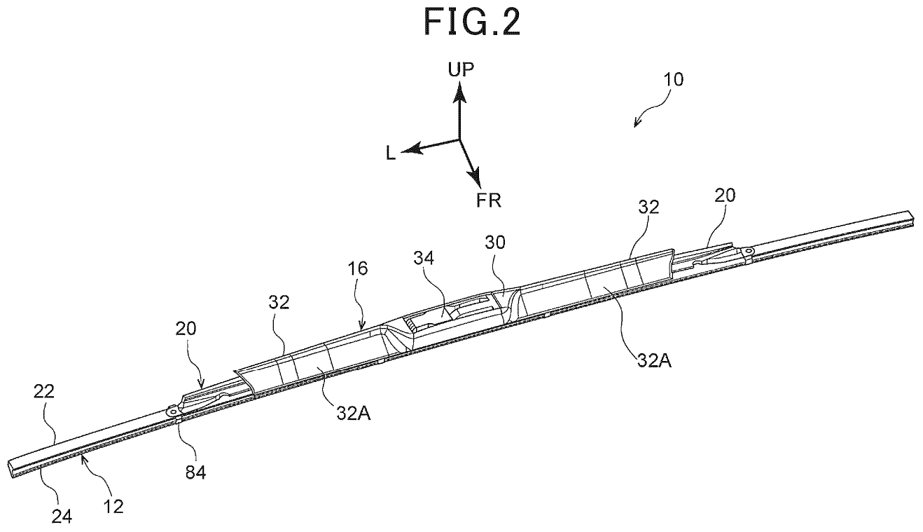

As shown in FIGS. 2 and 5, the arm part 32 in one side of the lever 16 in the longitudinal direction is rotatably engaged to one side yoke member 20. Further, one wing member 18 disposed in one side in the longitudinal direction with respect to the lever 16 is rotatable engaged to one yoke member 20. Thus, the lever 16 and the one wing member 18 disposed in one side in the longitudinal direction with respect to the lever 16 are rotatably coupled in the longitudinal direction via one yoke member 20.

Similarly, the arm part 32 in the other side of the lever 16 in the longitudinal direction is rotatably engaged to the other yoke member 20. Also, the other wing member 18 disposed in the other side in the longitudinal direction with respect to the lever 16, is rotatably engaged to the other yoke member 20. Thus, the lever 16 and the other wing member 18 disposed in the other side in the longitudinal direction with respect to the lever 16 are rotatably coupled in the longitudinal direction via the other yoke member 20.

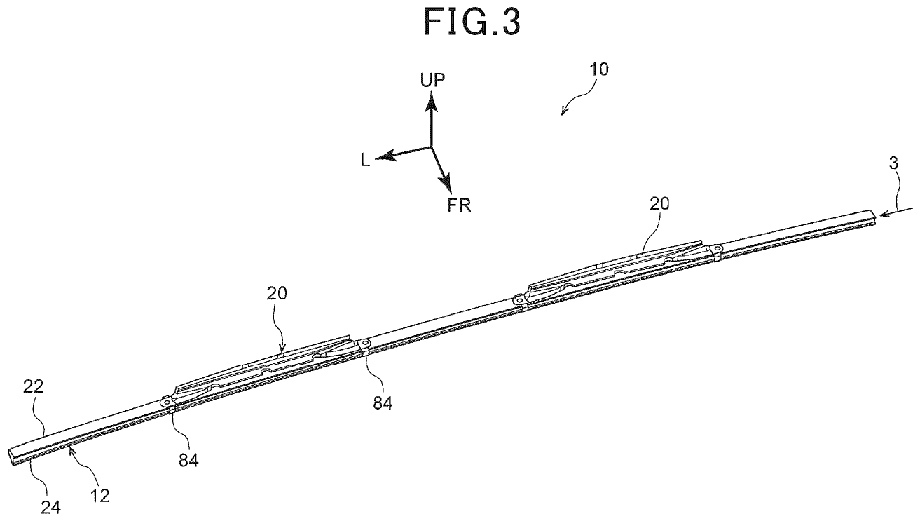

As shown in FIGS. 3 and 5, a grip member 84 (second grip member) with which a longitudinal intermediate part of the blade rubber 12 is gripped, is formed at both end parts of the yoke member 20 in the longitudinal direction. Each of the grip members 84 has a pair of grip pieces 84A extending in the lower side of the yoke member 20 from the front end part and the rear end part thereof. The tip end part (lower end part) of the grip piece 84A in the front and rear sides are bent approaching each other, and inserted into the above-described pair of support grooves 28 from longitudinal other end part to be engaged therewith. Thus, a longitudinal intermediate part of the blade rubber 12 is gripped (supported) by respective grip parts 84.

### (Detailed Configuration of Lever 16)

Next, detailed configuration of the lever 16 will be described.

As shown in FIG. 6, the coupling part 30 of the lever 16 is formed in a rectangular frame shape when viewed from the vertical direction as described above, and the coupling part 30 penetrates in the vertical direction and opens in a rectangular shape. In more detail, the coupling part 30 of the lever 16 is provided with a pair of side wall parts 88 arranged in the front-rear direction as an axial direction of the coupling shaft 86 with an interval therebetween, and a pair of connection wall parts 90 each connecting end parts at one side in the longitudinal direction of the pair of side wall parts 88, to be connected in the front-rear direction, and connecting end parts at the other side in the longitudinal of the pair of side wall parts 88, to be connected in the front-rear direction. The pair of side wall parts 88 are each formed in a rectangular plate shape extending in the vertical direction and the longitudinal direction with a thickness direction as the front-rear direction. Also, an intermediate part of the center part in the longitudinal direction of the pair of side wall parts 88 is connected to the coupling shaft 86 in the front-rear direction. Further, the coupling shaft 86 is integrally formed with a resin material for forming the lever 16 to have a cylindrical shape of which the axial direction is the front-rear direction.

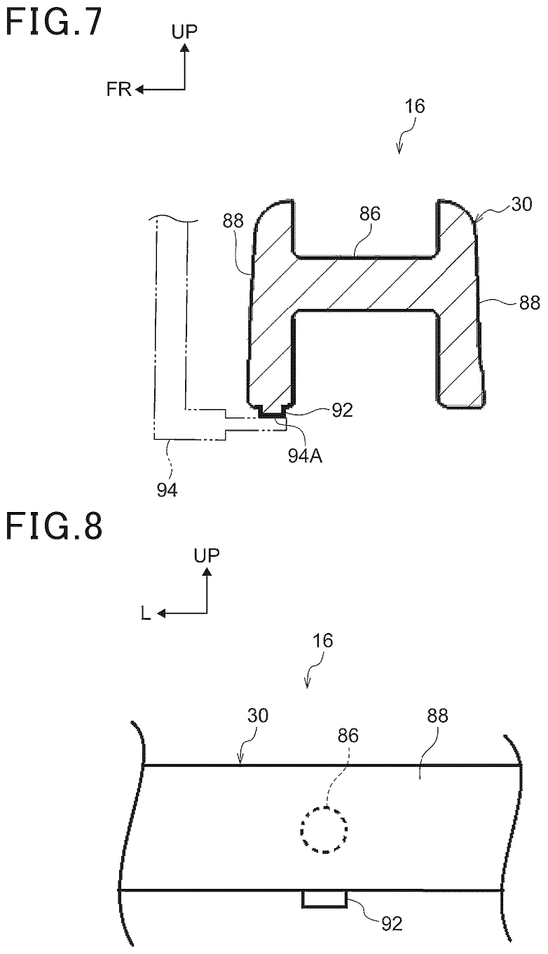

As shown in FIGS. 6 and 7, a convex part 92 is formed at a center part between an end part of one arm part 32 opposite to the coupling part 30 and an end part of the other arm part 32 opposite to the coupling part 30, in other words, at a center part in the entire longitudinal length of the lever 16. The convex part 92 is formed in a substantially cylindrical shape protruding from the coupling part 30. Note that a direction extending from an end part of one arm part 32 opposite to the coupling part 30 to an end part of the other arm part 32 opposite to the coupling part 30 corresponds to the longitudinal direction of the wiper blade 10. As shown in FIGS. 6 to 8, the convex part 92 protrudes from the lower end of the side wall part 88 in the front side (end part of the blade rubber 12 side) to the lower side. Further, as shown in FIG. 8, when viewed from the axial direction of the coupling shaft 86, at least a part of the convex part 92 and at least a part of the coupling shaft 86 are disposed at the same location in the longitudinal direction (i.e. location overlapping in the longitudinal direction). According to the present embodiment, when viewed from the axial direction of the coupling shaft 86, the most part of the convex part 92 in the longitudinal direction and the most part of the coupling shaft 86 are disposed at the same location.

Here, in FIG. 7, a two-dot chain line indicates a path 94 of a resin material flowing into a mold for manufacturing the lever 16. As shown in the drawing, according to the present embodiment, the resin material is filled into the mold from a location corresponding to the tip end part of the convex part 92 in the protrusion direction as a gate 94A communicating with the cavity. Note that the gate 94A serves an inlet when the resin material is filled. The convex part 92 serves as a part where a gate remains as a molding mark of the lever 16. Further, the convex part 92 may be referred to as a gate mark.

### Effects and Advantages of the Present Embodiment

Next, effects and advantages of the present embodiment will be described.

As shown in FIGS. 1, 6 to 8, for the lever 16 that constitutes a part of the wiper blade 10 according to the present embodiment as described above, the convex part 92 protruding from the coupling part 30 is formed at a center part between an end part of one arm part 32 opposite to the coupling part 30 and an end part of the other arm part 32 opposite to the coupling part 30. A resin material is filled into the mold from the gate 94A positioned at a location corresponding to the tip end part of the convex part 92 in the protrusion direction, whereby the resin material is filled from the center part of the entire longitudinal length of the lever 16. Hence, the filling pressure for entirely filling the mold can be the same pressure between one side and the other side in the longitudinal direction. As a result, compared to a case where the position of the gate 94A is deviated to either one side in the longitudinal direction, the filling pressure of the resin material can be lowered. Thus, the resin material can be uniformly filled into the mold with a relatively low pressure.

Also, according to the present embodiment, when viewed from the axial direction of the coupling shaft 86, the most part of the convex part 92 in the longitudinal direction and the most part of the coupling shaft 86 in the longitudinal direction are arranged at the same position in the longitudinal direction (position overlapping in the longitudinal direction). According to the present embodiment, the resin material filled from the convex part 92 side smoothly flows to the coupling shaft 86 side from one side wall part 88. Thus, a weld 100 (described later) can be prevented or suppressed from being formed at the coupling shaft 86 to which a pressing force from the wiper arm or a wiping resistance force is likely to be applied. Also, according to the present embodiment, the pair of side wall parts 88 are connected via the coupling shaft 86. Thus, the resin material filled into a portion of one side wall part 88 is caused to smoothly flow into a portion of the other side wall part 88 via the coupling shaft 86.

Further, according to the present embodiment, the convex part 92 protrudes from the lower end of one side wall part 98 (end part of the blade rubber 12 side) towards the lower side. Thus, since the convex part 92 is provided at a portion different from a portion constituting the appearance design surface in a state where the wiper blade can be operated, the convex part 92 can be prevented from being visually recognized. Therefore, designability of the wiper blade 10 can be prevented from being impaired.

### (Lever 96 of the Second Embodiment)

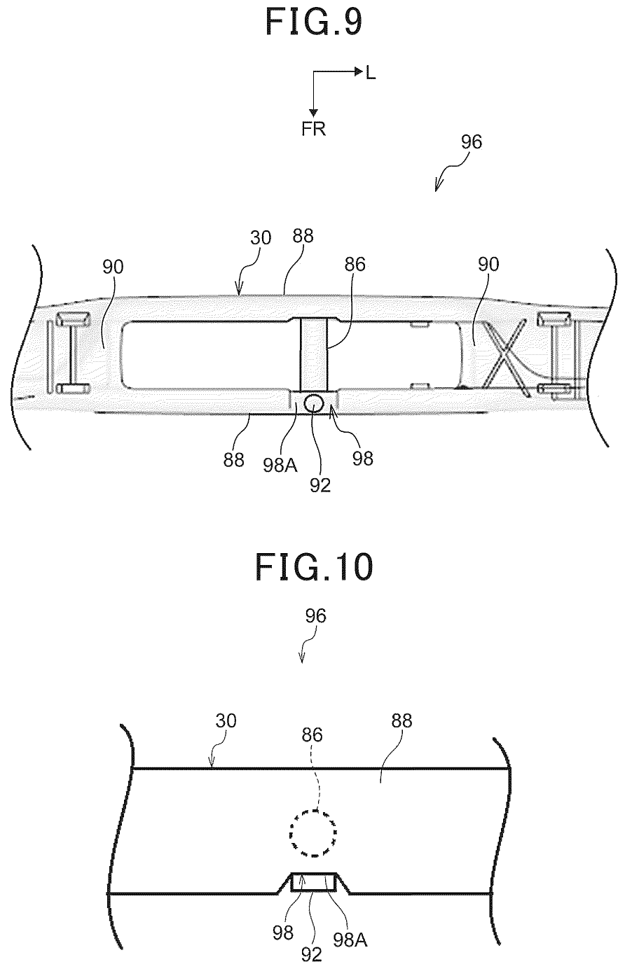

Next, with reference to FIGS. 9 and 10, a lever 96 according to the second embodiment will be described. For portions in the lever 96 of the second embodiment which correspond to the lever 16 of the first embodiment, the same reference numbers as those in the lever 16 of the first embodiment are applied and the explanation thereof may be omitted.

As shown in FIGS. 9 and 10, a recess 98 is formed in the coupling part 30 of the lever 96 according to the present embodiment. A recess 98 is formed in a lower part of the side wall part 88 in the front side, and the lower side thereof is opened. Further, the convex part 92 protrudes towards an opening end side (lower side) of the recess 98 from a bottom part 98A of the recess 98. Note that other configurations of the lever 96 according to the present embodiment are the same as those in the first embodiment.

Also with the lever 96 according to the above-described present embodiment, the location corresponding to the tip end part in the protrusion direction of the convex part 92 is used as the gate 94A for filling the resin material into the mold, whereby the resin material can be uniformly filled into the mold with a relatively low pressure.

Further, according to the lever 96 of the present embodiment, the convex part 92 protrudes towards an opening end side (lower side) of the recess 98 from a bottom part 98A of the recess 98. In other words, at least a part of the base end side of the convex part 92 in the protrusion direction is accommodated in the recess 98. Thus, an amount of protrusion from the lower end part of the side wall part 88 of the convex part 92 can be smaller or removed.

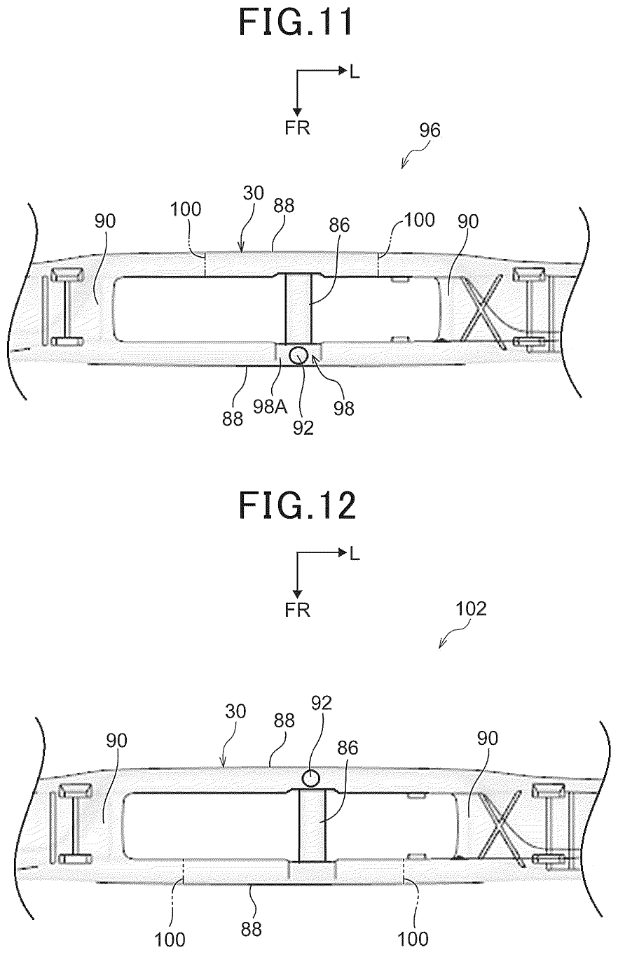

FIG. 11 is a diagram schematically showing a location of a weld 100 produced when filling the resin material into the mold for manufacturing the lever 96. Note that the weld 100 is a portion produced when resin materials flowing from different direction are merged. As shown in FIG. 11, according to the lever 96 of the present embodiment, the weld 100 is produced at both sides in the longitudinal direction of the side wall part 88 in the rear side, but no weld 100 is produced at the coupling shaft 86. Thus, it is understood that the whole coupling shaft 86 is formed by a resin-flow in the same direction.

FIG. 12 is a diagram similar to FIG. 11, showing the lever 102 according to the third embodiment in which the convex part 92 is formed at the center part in the longitudinal direction of the side wall part 88 in the rear side. As shown in FIG. 12, according to the lever 102, the weld 100 is produced at both sides in the longitudinal direction of the side wall part 88 in the front side, but no weld 100 is produced at the coupling shaft 86. Thus, it is realized that the whole coupling shaft 86 is formed by a resin-flow in the same direction.

As described above, the convex part 92 formed corresponding to a location of the gate 94A communicating to the cavity part of the mold, is provided at the center part in the longitudinal direction of the levers 96 and 102, whereby the weld 100 can be prevented or suppressed from being formed at the coupling shaft 86. FIG. 13 is a diagram similar to FIG. 11, showing a lever 104 according to a comparative example in which the convex part 92 is formed at the center part in the front-rear direction of one connection wall part 90. According to the lever 104 of the comparative example, the weld 100 is formed at the center part in the front-rear direction of the coupling shaft 86. As a result, compared to a case where the weld 100 is not formed at the coupling shaft 86, the lever 104 according to the comparative example lowers the strength of the coupling shaft 86.

### (Lever 106 of Fourth Embodiment)

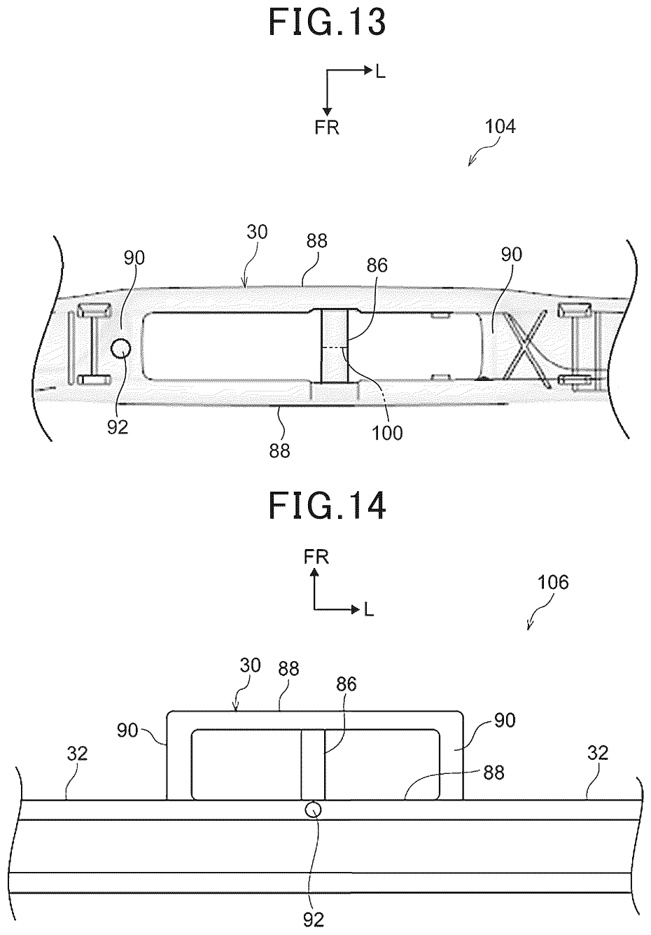

Next, with reference to FIG. 14, a lever 106 according to the fourth embodiment will be described. For portions in the lever 106 of the fourth embodiment which correspond to the lever 16 of the first embodiment, the same reference numbers as those in the lever 16 of the first embodiment are applied and the explanation thereof may be omitted.

As shown in FIG. 14, according to the lever 106 of the present embodiment, the coupling part 30 is disposed to be offset in the axial direction of the coupling shaft 86 with respect to the pair of arm parts 32. Then, the convex part 92 protrudes from the side wall part 88 in the arm part 32 side of the coupling part 30. In other words, the side wall part 88 in the rear side of the coupling part 30 and a part of the side wall in the front side of the arm part 32 are formed to be mutually shared, and the convex part 92 is provided at the shared side wall part 88.

Also with the lever 106 according to the above-described present embodiment, the location corresponding to the tip end part in the protrusion direction of the convex part 92 is used as the gate 94A for filling the resin material into the mold, whereby the resin material can be uniformly filled into the mold with a relatively low pressure. Moreover, since the convex part 92 where the gate 94A is positioned, is provided at the side wall part 88 in the rear side of the coupling part 30 which is formed being mutually shared with a part of the side wall in the front side of the arm part 32, the resin material can smoothly flow from the location of the convex part 92 towards both parts of the coupling part 30 and the pair of arm parts 32.

According to the above-described embodiments, the wiper blade is configured to have a tournament chart structure. This is not limited thereto. For example, a wiper blade may be configured such that the yoke member is omitted and a grip member is formed at both end parts in the longitudinal direction of the lever 16 for gripping the blade rubber 12. Embodiments of the present disclosure are described so far. The present disclosure is not limited to the above-described embodiments and the above-described embodiments may be modified in various manners without departing from the spirit of the present disclosure.

The present disclosure has been described in accordance with the embodiments. However, the present disclosure is not limited to the embodiments and structure thereof. The present disclosure includes various modification examples and modifications within the equivalent configurations. Further, various combinations and modes and other combinations and modes including one element or more or less elements of those various combinations are within the range and technical scope of the present disclosure.

### APPENDIX

### Appendix 1

A lever member (16, 96, 102, 106) made of resin that constitutes a part of a wiper lever assembly (14) that supports a blade rubber (12), the lever member comprising:
a coupling part (30) having a coupling shaft (86) to be coupled to a wiper arm;
a pair of arm parts (32) extending in mutually different directions from the coupling part, the pair of arm parts being a first arm part and a second arm part; and
a convex part (92) protruding from the coupling part, formed at a center part between an end part of a first arm part opposite to the coupling part and an end part of a second arm part opposite to the coupling part.

### Appendix 2

The lever member according to appendix 1,

wherein
a recess (98) is formed at the coupling part; and
at least a part of the convex part protrudes, in a state of being accommodated in the recess (98), towards an opening end side of the recess from a bottom part (98A) of the recess.

### Appendix 3

The lever member according to appendix 1 or 2,

wherein
a longitudinal direction is defined as a direction extending from an end part of the first arm part opposite to the coupling part to an end part of the second arm part opposite to the coupling part; and
when viewed from an axial direction of the coupling shaft, at least a part of the convex part and at least a part of the coupling shaft are disposed at the same location in the longitudinal direction.

### Appendix 4

The lever member according to appendix 1 or 2,

wherein
the convex part protrudes from an end part in the blade rubber side of the coupling part.

### Appendix 5

The lever member according to any one of appendixes 1 to 4,

wherein
the coupling part is provided with a pair of side wall parts (88) arranged in an axial direction of the coupling shaft with an interval therebetween and connected via the coupling shaft; and
the coupling part protrudes from one of the side wall parts.

### Appendix 6

The lever member according to appendix 5,

wherein
the coupling part is disposed to be offset in the axial direction of the coupling shaft with respect to the pair of arm parts; and
the convex part protrudes from the side wall part in an arm part side of the coupling part.

### Appendix 7

A wiper lever assembly comprising:
a lever member made of resin that constitutes a part of a wiper lever assembly that supports a blade rubber, the lever member comprising:
   a coupling part having a coupling shaft to be coupled to a wiper arm;
   a pair of arm parts extending in mutually different directions from the coupling part, the pair of arm parts being a first arm part and a second arm part; and
   a convex part protruding from the coupling part, formed at a center part between an end part of a first arm part opposite to the coupling part and an end part of a second arm part opposite to the coupling part;
a pair of wing members (18) arranged continuously with the lever member at a portion of a first arm part opposite to the coupling part and a portion of a second arm part opposite to the coupling part respectively, the pair of wing members each having a first grip member (60) that grips the blade rubber; and
a pair of yoke members (20) to which the lever member and the pair of wing members are rotatably coupled, having a second grip member (84) that grips the blade rubber.

### Appendix 8

A wiper blade (10) comprising:
a blade rubber that wipes a wiping surface of a vehicle; and
a wiper lever assembly according to appendix 7;
   wherein
the first grip members of the pair of wing members and the second grip members of the pair of yoke member grip the blade rubber, thereby supporting the blade rubber.

### CONCLUSION

As described, the present disclosure provides a lever member, a wiper lever assembly and a wiper blade in which a resin material is capable of being filled into the mold uniformly with a relatively low pressure during the resin-filling process for filling the resin material inside the mold.

As a first aspect of the present disclosure, a lever member is made of resin that constitutes a part of a wiper lever assembly that supports a blade rubber, including: a coupling part having a coupling shaft to be coupled to a wiper arm; a pair of arm parts extending in mutually different directions from the coupling part, the pair of arm parts being a first arm part and a second arm part; and a convex part protruding from the coupling part, formed at a center part between an end part of a first arm part opposite to the coupling part and an end part of a second arm part opposite to the coupling part.

Moreover, a wiper lever assembly is provided with the above-described lever member; a pair of wing members arranged continuously with the lever member at a portion of a first arm part opposite to the coupling part and a portion of a second arm part opposite to the coupling part respectively, the pair of wing members each having a first grip member that grips the blade rubber; and a pair of yoke members to which the lever member and the pair of wing members are rotatably coupled, having a second grip member that grips the blade rubber.

Further, a wiper blade is provided with a blade rubber that wipes a wiping surface of a vehicle; and the above-described wiper lever assembly in which the first grip members of the pair of wing members and the second grip members of the pair of yoke member grip the blade rubber, thereby supporting the blade rubber.

Thus, with the above-describe configuration, a resin material can be filled into the mold uniformly with a relatively low pressure during the resin-filling process for filling the resin material inside the mold.

What is claimed is:

1. A lever member made of resin that constitutes a part of a wiper lever assembly that supports a blade rubber, the lever member comprising:
a coupling part having a coupling shaft to be coupled to a wiper arm;
a pair of arm parts extending in mutually different directions from the coupling part, the pair of arm parts being a first arm part and a second arm part; and
a convex part protruding from the coupling part, formed at a center part between an end part of a first arm part opposite to the coupling part and an end part of a second arm part opposite to the coupling part.

2. The lever member according to claim 1,
wherein
a recess is formed at the coupling part; and
at least a part of the convex part protrudes, in a state of being accommodated in the recess, towards an opening end side of the recess from a bottom part of the recess.

3. The lever member according to claim 1,
wherein
a longitudinal direction is defined as a direction extending from an end part of the first arm part opposite to the coupling part to an end part of the second arm part opposite to the coupling part; and
when viewed from an axial direction of the coupling shaft, at least a part of the convex part and at least a part of the coupling shaft are disposed at the same location in the longitudinal direction.

4. The lever member according to claim 1,
wherein
the convex part protrudes from an end part in the blade rubber side of the coupling part.

5. The lever member according to claim 1,
wherein
the coupling part is provided with a pair of side wall parts arranged in an axial direction of the coupling shaft with an interval therebetween and connected via the coupling shaft; and
the coupling part protrudes from one of the side wall parts.

6. The lever member according to claim 5,
wherein
the coupling part is disposed to be offset in the axial direction of the coupling shaft with respect to the pair of arm parts; and
the convex part protrudes from the side wall part in an arm part side of the coupling part.

7. A wiper lever assembly comprising:
a lever member made of resin that constitutes a part of a wiper lever assembly that supports a blade rubber, the lever member comprising:
a coupling part having a coupling shaft to be coupled to a wiper arm;
a pair of arm parts extending in mutually different directions from the coupling part, the pair of arm parts being a first arm part and a second arm part; and
a convex part protruding from the coupling part, formed at a center part between an end part of a first arm part opposite to the coupling part and an end part of a second arm part opposite to the coupling part;
a pair of wing members arranged continuously with the lever member at a portion of a first arm part opposite to the coupling part and a portion of a second arm part opposite to the coupling part respectively, the pair of wing members each having a first grip member that grips the blade rubber; and
a pair of yoke members to which the lever member and the pair of wing members are rotatably coupled, having a second grip member that grips the blade rubber.

8. A wiper blade comprising:
a blade rubber that wipes a wiping surface of a vehicle;
a wiper lever assembly comprising:
a lever member made of resin that constitutes a part of a wiper lever assembly that supports a blade rubber, the lever member comprising:
a coupling part having a coupling shaft to be coupled to a wiper arm;
a pair of arm parts extending in mutually different directions from the coupling part, the pair of arm parts being a first arm part and a second arm part; and
a convex part protruding from the coupling part, formed at a center part between an end part of a first arm part opposite to the coupling part and an end part of a second arm part opposite to the coupling part;
a pair of wing members arranged continuously with the lever member at a portion of a first arm part opposite to the coupling part and a portion of a second arm part opposite to the coupling part respectively, the pair of wing members each having a first grip member that grips the blade rubber; and
a pair of yoke members to which the lever member and the pair of wing members are rotatably coupled, having a second grip member that grips the blade rubber,
wherein
the first grip members of the pair of wing members and the second grip members of the pair of yoke member grip the blade rubber, thereby supporting the blade rubber.
